(19) United States
(12) Patent Application Publication
(10) Pub. No.: US 2021/0368587 A1
(43) Pub. Date: Nov. 25, 2021

(54) SWINGABLE SOLAR ELECTRIC HEATER

(71) Applicant: Yuyao Feite Plactic Co., Ltd., Zhejiang Province (CN)

(72) Inventor: Gaoli Ge, Zhejiang (CN)

(21) Appl. No.: 17/041,274

(22) PCT Filed: Apr. 12, 2019
(86) PCT No.: PCT/CN2019/082525

§ 371 Date: Sep. 24, 2020

(30) Foreign Application Priority Data
Jun. 19, 2018 (CN) 201810631508.X

(51) Int. Cl. H05B 1/02; G06T 7/70; G06T 7/11; G06T 5/00; F24D 19/10; F24D 13/02

(52) U.S. Cl. CPC H05B 1/0277; G06T 7/70; G06T 7/11; G06T 5/003; F24D 2200/08; F24D 13/02; G06T 2207/20032; G06T 2207/20221; F24D 19/1096

(57) ABSTRACT

A swingable solar electric heater comprises an electric heater structure including a head swing element, a heating element, a timer, a base, and a safety dump switch. The head swing element is used to swing back and forth to perform radiant heating within a fixed angle, the timer is connected to the heating element, and the safety dump switch is used to turn off the heating element when the tilt angle of the base exceeds a limit. A current capture device captures the image data of the scene where the electric heater structure is located to obtain and output the corresponding current scene image. An early warning control device is used to extract each pixel value of each pixel in the current scene image, to calculate the standard deviation in the current scene image, and to send a blockage warning signal when the standard deviation exceeds a limit.

### TECHNICAL FIELD

The present invention relates to the field of solar electric heaters, in particular to a swingable solar electric heater.

### BACKGROUND ART

Solar electric heaters are very similar to ordinary household electric fans in appearance, except that there are no fan blades. It mainly uses a quartz heating element to conduct heat through radiation. Similar to ordinary electric fans, reflective electric heaters are also divided into desktop and floor-standing.

Of course, there are products with strange shapes such as ellipses and shells. The biggest feature of this product is that the direction of the fan surface (that is, the heating direction) will be illuminated, which is somewhat similar to Bathroom Heaters.

### SUMMARY OF THE INVENTION

In order to solve the technical problem of the low intelligence level of current electric heaters, the present invention provides a swingable solar electric heater, which adopts a swinging element to start swinging back and forth when receiving a human body matching signal, and to stop the back and forth swinging when receiving a human body unmatched signal, so as to prevent over-irradiation of human body. Specifically, each target shape in the image is identified to determine the distribution of edge lines in the image, and the image is sharpened instantly based on the distribution of edge lines. A two-stage filtering mode and adaptive binary threshold adjustment mode is used to improve the effect of image preprocessing. The image processing strategy is enhanced through custom analysis of the image, includes starting the median filtering operation on the image prior to confirmation of the blockage, to replace the image output with the filtered image, and wirelessly send the blockage alarm signal to the remote management server when the blockage is determined, so that remote control measures can be taken to overcome the blockage problem on the spot.

According to one aspect of the present invention, a swingable solar electric heater is provided. The heater comprises:

an electric heater structure, including a head swing element, a heating element, a timer, a base, and a safety dump switch, wherein the head swing element is used to swing back and forth to perform radiant heating within a fixed angle, the heating element is provided on the head swing element, the timer is connected to the heating element, and the safety dump switch is used to turn off the heating element and stop its heating operation when the tilt angle of the base is detected to exceed a limit.

More specifically, the swingable solar electric heater further comprises:

a current capture device, which captures the image data of the scene where the electric heater structure is located to obtain and output the corresponding current scene image; an early warning control device, which is connected to the current capture device, and is used to receive the current scene image, to extract each pixel value of each pixel in the current scene image, to calculate the standard deviation based on each pixel value of each pixel in the current scene image, to send an blockage warning signal when the standard deviation exceeds a limit, and to send an unblocked prompt signal when the standard deviation does not exceed a limit.

More specifically, the swingable solar electric heater further comprises:

a sub-image composition device, which is connected to the early warning control device, and is used to extract each brightness value of each pixel in the current scene image when receiving the blockage warning signal, to use the pixels of brightness value less than or equal to a preset brightness threshold as blockage pixels, to remove the isolated blockage pixels in the current scene image, and to compose each of the non-isolated blockage pixel in the current scene image into blockage sub-images.

More specifically, the swingable solar electric heater further comprises:

an blockage measurement device, which is connected to the sub-image composition device, and is used to receive each blockage sub-image in the current scene image, to calculate the number of pixels occupied by each blockage sub-image as the area of the corresponding blockage sub-image, to remove the blockage sub-images whose area is less than or equal to the preset area threshold, to accumulate each area of the remaining blockage sub-images to obtain the total blockage area, to send an blockage alarm signal when the total blockage area exceeds a limit, and to send an blockage unconfirmed signal when the total blockage area does not exceed a limit; a decision control device, which is connected to the blockage measurement device, and is used to initiate a median filtering operation on the current scene image when the blockage unconfirmed signal is received, so as to replace the current scene image output with the filtered image, also used to wirelessly send the blockage alarm signal to the remote management server after receiving the blockage alarm signal; a recursive filtering device, which is connected to the current capturing device, and is used to receive the current scene image, to perform self-adaptive recursive filtering processing on the current scene image, to obtain and output a recursive filtered image; a Wiener filtering device, which is connected to the recursive filtering device, and is used to receive the recursive filtered image, and performing Wiener filtering processing of different strengths based on the magnitude of noise in the recursive filtering image to obtain the corresponding Wiener filtered image; an intelligent blocking device, which is connected to the Wiener filtering device, and is used to receive the Wiener filtered image, to determine the blur degree of the Wiener filtered image, and to divide the Wiener filtered image into blocks based on the blur degree of the Wiener-filtered image to obtain a plurality of image blocks of the same size; a parameter adjustment device, which is connected to the intelligent blocking device, and is used to receive the plurality of image blocks, and perform the following processing on each image block: to obtain the binary threshold of the image block based on the OTSU algorithm, to obtain each binary threshold of each image block in the neighborhood of the image block based on the OTSU algorithm, and to adjust the binary threshold of the image block based on each binary threshold of each image block in the neighborhood of the image block to obtain and output the adjusted threshold of the image block; in the parameter adjustment device, the adjusted threshold of the image block obtained by adjusting the binary threshold of the image block based on each binary threshold of each image block in the neighborhood of the image block comprises: the higher the degree of matching between the neighboring image block and the image block, the greater the degree of influence of the neighboring image block on the binary threshold of the image block; a binarization execution device, which is connected to the parameter adjustment device, and is used to receive the plurality of image blocks and the adjusted threshold corresponding to each image block, and to perform binarization processing on the image blocks to obtain binarized blocks based on the adjusted threshold corresponding to each image block, and output respective binarized blocks corresponding to each image block; a block combining device, which is connected to the binarization execution device, and is used to receive and merge the respective binarized blocks, to perform edge fusion on the merged image to obtain a fused image, and output as a combined image of blocks; a line measurement device, which is connected to the block combining device, and is used to receive the combined image of blocks, to detect each edge line in the combined image of blocks to obtain the number of edge lines in the combined image of blocks, and to send a no-sharpening message when the number of edge lines in the combined image of blocks does not exceed the preset number threshold, and also used to send a sharpening trigger message when the number of edge lines in the combined image of blocks exceeds the preset number threshold; an instant operation device, which is connected to the line measurement device, and is used to start the real-time sharpening process of the combined image of blocks when the sharpening trigger message is received, so as to obtain the corresponding instant operation image, and also used to output the combined image of blocks directly as an instant operation image without performing real-time sharpening process on the combined image of blocks when receiving the sharpening trigger message; a first extraction device, which is connected to the instant operation device, and is used to receive an instant operation image, to extract the corresponding human body area to be detected from the instant operation image based on a preset standard human body shape, to perform normalization process of the human body area to be detected and the preset standard human body shape respectively to obtain a first normalized image and a second normalized image, to obtain a difference image by subtracting the first normalized image from the second normalized image, to extract the number of pixels with non-zero pixel values in the difference image, and output the extracted number as the number of difference pixels; a second extraction device, which is connected to the first extraction device, and is used to receive the number of difference pixels, to extract the total number of pixels in the first normalized image, to send human body matching signal when the ratio of number of difference pixels to the total number of pixels is less than or equal to the preset ratio threshold, or otherwise to send human body unmatching signal; wherein, the safety dump switch is also used to turn on the heating element so as to start its heating operation when it is detected that the tilt angle of the base has not exceeded the limit.

More specifically, in the swingable solar electric heater: the head swing element starts to swing back and forth when receiving the human body matching signal, and stops swinging back and forth when receiving the human body unmatching signal.

More specifically, in the swingable solar electric heater: the size of the filtering window used in the median filtering operation is proportional to the total area of the blockage.

More specifically, in the swingable solar electric heater: in the intelligent blocking device, the smaller the degree of blurring of the Wiener filtered image, the greater the number of image blocks obtained by performing blocking processing on the Wiener filtered image.

More specifically, in the swingable solar electric heater: detecting each edge line in the combined image of blocks using the line measurement device to obtain the number of edge lines in the combined image of blocks which includes: identifying each target shape in the combined image of blocks, whereby one or more lines composing each target shape are regarded as one or more edge lines.

### DESCRIPTION OF ACCOMPANY FIGURES

The embodiments of the present invention will be described below with reference to the accompanying FIGURE, in which:

FIG. 1 is a schematic structural view of the swingable solar heater according to the embodiments of the present invention.

### DETAILED DESCRIPTION

With reference to the FIGURE, the embodiments of the swingable solar electric heater of the present invention will be described in detail below.

Solar electric heaters consume oxygen in the room. As there is no protection device in the design, the powerful starting current will reduce its service life.

Advantages: fast heating speed, concentrated heat energy, complex functions (high-end products are equipped with timing, far infrared health care and humidification functions).

Disadvantages: a small heating range tends to cause indoor light pollution, which is not favorable to use during sleeping hours. Moreover, due to its “top-heavy” design, there will be a risk of electricity leakage once the heater falls or splashes with water.

In order to overcome the above shortcomings, the present invention builds a swingable solar electric heater, which can effectively solve the corresponding technical problems.

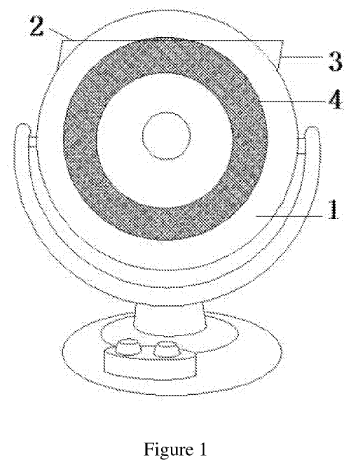

FIG. 1 is a schematic structural diagram of the swingable solar electric heater according the embodiments of the present invention. The electric heater comprises:

an electric heater structure, including a head swing element 1, a heating element 4, a timer, a base, and a safety dump switch. The head swing element is used to swing back and forth to perform radiant heating within a fixed angle, the heating element is provided on the head swing element, the timer is connected to the heating element, and the safety dump switch is used to turn off the heating element and stop its heating operation when the tilt angle of the base is detected to exceed a limit. The electric heater structure further includes a dryer cross beam 2 and a dryer side beam 3.

Next, the specific structure of the swingable solar electric heater of the present invention will be further described.

The swingable solar electric heater further comprises:

a current capture device, which captures the image data of the scene where the electric heater structure is located to obtain and output the corresponding current scene image;

an early warning control device, which is connected to the current capture device, and is used to receive the current scene image, to extract each pixel value of each pixel in the current scene image, to calculate the standard deviation based on each pixel value of each pixel in the current scene image, to send an blockage warning signal when the standard deviation exceeds limit, and to send an unblocked prompt signal when the standard deviation does not exceed limit.

The swingable solar electric heater further comprises:

a sub-image composition device, which is connected to the early warning control device, and is used to extract each brightness value of each pixel in the current scene image when receiving the blockage warning signal, to use the pixels of brightness value less than or equal to a preset brightness threshold as blockage pixels, to remove the isolated blockage pixels in the current scene image, and to compose each of the non-isolated blockage pixel in the current scene image into blockage sub-images.

The swingable solar electric heater further comprises:

an blockage measurement device, which is connected to the sub-image composition device, and is used to receive each blockage sub-image in the current scene image, to calculate the number of pixels occupied by each blockage sub-image as the area of the corresponding blockage sub-image, to remove the blockage sub-images whose area is less than or equal to the preset area threshold, to accumulate each area of the remaining blockage sub-images to obtain the total blockage area, to send an blockage alarm signal when the total blockage area exceeds limit, and to send an blockage unconfirmed signal when the total blockage area does not exceed limit;

a decision control device, which is connected to the blockage measurement device, and is used to initiate a median filtering operation on the current scene image when the blockage unconfirmed signal is received, so as to replace the current scene image output with the filtered image, also used to wirelessly send the blockage alarm signal to the remote management server after receiving the blockage alarm signal;

a recursive filtering device, which is connected to the current capturing device, and is used to receive the current scene image, to perform self-adaptive recursive filtering processing on the current scene image, to obtain and output a recursive filtered image;

a Wiener filtering device, which is connected to the recursive filtering device, and is used to receive the recursive filtered image, and performing Wiener filtering processing of different strengths based on the magnitude of noise in the recursive filtering image to obtain the corresponding Wiener filtered image;

an intelligent blocking device, which is connected to the Wiener filtering device, and is used to receive the Wiener filtered image, to determine the blur degree of the Wiener filtered image, and to divide the Wiener filtered image into blocks based on the blur degree of the Wiener-filtered image to obtain a plurality of image blocks of the same size;

a parameter adjustment device, which is connected to the intelligent blocking device, and is used to receive the plurality of image blocks, and perform the following processing on each image block: to obtain the binary threshold of the image block based on the OTSU algorithm, to obtain each binary threshold of each image block in the neighborhood of the image block based on the OTSU algorithm, and to adjust the binary threshold of the image block based on each binary threshold of each image block in the neighborhood of the image block to obtain and output the adjusted threshold of the image block; in the parameter adjustment device, the adjusted threshold of the image block obtained by adjusting the binary threshold of the image block based on each binary threshold of each image block in the neighborhood of the image block comprises: the higher the degree of matching between the neighboring image block and the image block, the greater the degree of influence of the neighboring image block on the binary threshold of the image block;

a binarization execution device, which is connected to the parameter adjustment device, and is used to receive the plurality of image blocks and the adjusted threshold corresponding to each image block, and to perform binarization processing on the image blocks to obtain binarized blocks based on the adjusted threshold corresponding to each image block, and output respective binarized blocks corresponding to each image block;

a block combining device, which is connected to the binarization execution device, and is used to receive and merge the respective binarized blocks, to perform edge fusion on the merged image to obtain a fused image, and output as a combined image of blocks;

a line measurement device, which is connected to the block combining device, and is used to receive the combined image of blocks, to detect each edge line in the combined image of blocks to obtain the number of edge lines in the combined image of blocks, and to send a no-sharpening message when the number of edge lines in the combined image of blocks does not exceed the preset number threshold, and also used to send a sharpening trigger message when the number of edge lines in the combined image of blocks exceeds the preset number threshold;

an instant operation device, which is connected to the line measurement device, and is used to start the real-time sharpening process of the combined image of blocks when the sharpening trigger message is received, so as to obtain the corresponding instant operation image, and also used to output the combined image of blocks directly as an instant operation image without performing real-time sharpening process on the combined image of blocks when receiving the sharpening trigger message;

a first extraction device, which is connected to the instant operation device, and is used to receive an instant operation image, to extract the corresponding human body area to be detected from the instant operation image based on a preset standard human body shape, to perform normalization process of the human body area to be detected and the preset standard human body shape respectively to obtain a first normalized image and a second normalized image, to obtain a difference image by subtracting the first normalized image from the second normalized image, to extract the number of pixels with non-zero pixel values in the difference image, and output the extracted number as the number of difference pixels;

a second extraction device, which is connected to the first extraction device, and is used to receive the number of difference pixels, to extract the total number of pixels in the first normalized image, to send human body matching signal when the ratio of number of difference pixels to the total number of pixels is less than or equal to the preset ratio threshold, or otherwise to send human body unmatching signal;

wherein, the safety dump switch is also used to turn on the heating element so as to start its heating operation when it is detected that the tilt angle of the base has not exceeded the limit.

In the swingable solar electric heater: the head swing element starts to swing back and forth when receiving the human body matching signal, and stops swinging back and forth when receiving the human body unmatching signal.

In the swingable solar electric heater: the size of the filtering window used in the median filtering operation is proportional to the total area of the blockage.

In the swingable solar electric heater: in the intelligent blocking device, the smaller the degree of blurring of the Wiener filtered image, the greater the number of image blocks obtained by performing blocking processing on the Wiener filtered image.

And in the swingable solar electric heater: detecting each edge line in the combined image of blocks using the line measurement device to obtain the number of edge lines in the combined image of blocks which includes: identifying each target shape in the combined image of blocks, whereby one or more lines composing each target shape are regarded as one or more edge lines.

In addition, different types of generic array logic devices (GAL) are used to implement the first extraction device and the second extraction device, respectively. Generic array logic (Generic Array Logic www.husoon.com) devices is the first PLD invented by LATTICE company in 1985 that can be electrically erasable, programmable, and settable with encryption bits. Typical GAL chips are GAL16V8 and GAL20. These two GALs can simulate almost all types of PAL devices. In practical applications, GAL devices are 100% compatible with PAL device emulations, so GAL can almost replace all PAL devices, and can replace most SSI and MSI digital integrated circuits, so it is widely used.

The biggest difference between GAL and PAL is that the output structure of GAL can be defined by the user and is a programmable output structure. Two basic models of GAL, GAL16V8 (20-pin) and GAL20V8 (24-pin) can replace dozens of kinds of PAL devices, so they are called generic programmable circuits. The output of PAL is defined by the manufacturer, and it is fixed after the chip is selected and cannot be changed by the user.

By adopting the swingable solar heater of the present invention, in view of the technical problem that the swing mode of the solar heater in the prior art lacks an effective control mechanism, a swinging element is used to start swinging back and forth when receiving a human body matching signal, and to stop the back and forth swinging when receiving a human body unmatched signal, so as to prevent over-irradiation of human body. Specifically, each target shape in the image is identified to determine the distribution of edge lines in the image, and the image is sharpened instantly based on the distribution of edge lines. A two-stage filtering mode and adaptive binary threshold adjustment mode is used to improve the effect of image preprocessing. The image processing strategy is enhanced through custom analysis of the image, includes starting the median filtering operation on the image prior to confirmation of the blockage, to replace the image output with the filtered image, and wirelessly send the blockage alarm signal to the remote management server when the blockage is determined, so that remote control measures can be taken to overcome the blockage problem on the spot, thus solving the above technical problems.

It can be understood that although the present invention has been disclosed as above through preferred embodiments. However, the above-mentioned embodiments are not intended to limit the present invention. For anyone skilled in the art, the technical content disclosed above can be used to make many possible changes, amendments or modifications into embodiments of equivalent effect to the technical solution of the present invention without departing from the scope of the technical solution of the present invention. Therefore, all simple amendments, equivalent changes and modifications made to the above embodiments based on the technical essence of the present invention without departing from the technical solution of the present invention still fall within the protection scope of the technical solution of the present invention.

What is claimed is:

1. A swingable solar electric heater, comprising:
an electric heater structure, including a head swing element, a heating element, a timer, a base, and a safety dump switch, wherein the head swing element is used to swing back and forth to perform radiant heating within a fixed angle, the heating element is provided on the head swing element, the timer is connected to the heating element, and the safety dump switch is used to turn off the heating element and stop its heating operation when the tilt angle of the base is detected to exceed a limit.

2. The swingable solar electric heater of claim 1, characterized in that, the electric heater further comprises:
a current capture device, which captures the image data of the scene where the electric heater structure is located to obtain and output the corresponding current scene image;
an early warning control device, which is connected to the current capture device, and is used to receive the current scene image, to extract each pixel value of each pixel in the current scene image, to calculate the standard deviation based on each pixel value of each pixel in the current scene image, to send an blockage warning signal when the standard deviation exceeds a limit, and to send an unblocked prompt signal when the standard deviation does not exceed a limit.

3. The swingable solar electric heater of claim 2, characterized in that, the electric heater further comprises:
a sub-image composition device, which is connected to the early warning control device, and is used to extract each brightness value of each pixel in the current scene image when receiving the blockage warning signal, to use the pixels of brightness value less than or equal to a preset brightness threshold as blockage pixels, to remove the isolated blockage pixels in the current scene image, and to compose each of the non-isolated blockage pixel in the current scene image into blockage sub-images.

4. The swingable solar electric heater of claim 3, characterized in that, the electric heater further comprises:
an blockage measurement device, which is connected to the sub-image composition device, and is used to receive each blockage sub-image in the current scene image, to calculate the number of pixels occupied by each blockage sub-image as the area of the corresponding blockage sub-image, to remove the blockage sub-images whose area is less than or equal to the preset area threshold, to accumulate each area of the remaining blockage sub-images to obtain the total blockage area, to send an blockage alarm signal when the total blockage area exceeds a limit, and to send an blockage unconfirmed signal when the total blockage area does not exceed a limit;
a decision control device, which is connected to the blockage measurement device, and is used to initiate a median filtering operation on the current scene image when the blockage unconfirmed signal is received, so as to replace the current scene image output with the filtered image, also used to wirelessly send the blockage alarm signal to the remote management server after receiving the blockage alarm signal;
a recursive filtering device, which is connected to the current capturing device, and is used to receive the current scene image, to perform self-adaptive recursive filtering processing on the current scene image, to obtain and output a recursive filtered image;
a Wiener filtering device, which is connected to the recursive filtering device, and is used to receive the recursive filtered image, and performing Wiener filtering processing of different strengths based on the magnitude of noise in the recursive filtering image to obtain the corresponding Wiener filtered image;
an intelligent blocking device, which is connected to the Wiener filtering device, and is used to receive the Wiener filtered image, to determine the blur degree of the Wiener filtered image, and to divide the Wiener filtered image into blocks based on the blur degree of the Wiener-filtered image to obtain a plurality of image blocks of the same size;
a parameter adjustment device, which is connected to the intelligent blocking device, and is used to receive the plurality of image blocks, and perform the following processing on each image block: to obtain the binary threshold of the image block based on the OTSU algorithm, to obtain each binary threshold of each image block in the neighborhood of the image block based on the OTSU algorithm, and to adjust the binary threshold of the image block based on each binary threshold of each image block in the neighborhood of the image block to obtain and output the adjusted threshold of the image block; in the parameter adjustment device, the adjusted threshold of the image block obtained by adjusting the binary threshold of the image block based on each binary threshold of each image block in the neighborhood of the image block comprises: the higher the degree of matching between the neighboring image block and the image block, the greater the degree of influence of the neighboring image block on the binary threshold of the image block;
a binarization execution device, which is connected to the parameter adjustment device, and is used to receive the plurality of image blocks and the adjusted threshold corresponding to each image block, and to perform binarization processing on the image blocks to obtain binarized blocks based on the adjusted threshold corresponding to each image block, and output respective binarized blocks corresponding to each image block;
a block combining device, which is connected to the binarization execution device, and is used to receive and merge the respective binarized blocks, to perform edge fusion on the merged image to obtain a fused image, and output as a combined image of blocks;
a line measurement device, which is connected to the block combining device, and is used to receive the combined image of blocks, to detect each edge line in the combined image of blocks to obtain the number of edge lines in the combined image of blocks, and to send a no-sharpening message when the number of edge lines in the combined image of blocks does not exceed the preset number threshold, and also used to send a sharpening trigger message when the number of edge lines in the combined image of blocks exceeds the preset number threshold;
an instant operation device, which is connected to the line measurement device, and is used to start the real-time sharpening process of the combined image of blocks when the sharpening trigger message is received, so as to obtain the corresponding instant operation image, and also used to output the combined image of blocks directly as an instant operation image without performing real-time sharpening process on the combined image of blocks when receiving the sharpening trigger message;
a first extraction device, which is connected to the instant operation device, and is used to receive an instant operation image, to extract the corresponding human body area to be detected from the instant operation image based on a preset standard human body shape, to perform normalization process of the human body area to be detected and the preset standard human body shape respectively to obtain a first normalized image and a second normalized image, to obtain a difference image by subtracting the first normalized image from the second normalized image, to extract the number of pixels with non-zero pixel values in the difference image, and output the extracted number as the number of difference pixels;
a second extraction device, which is connected to the first extraction device, and is used to receive the number of difference pixels, to extract the total number of pixels in the first normalized image, to send human body matching signal when the ratio of number of difference pixels to the total number of pixels is less than or equal to the preset ratio threshold, or otherwise to send human body unmatching signal;
wherein, the safety dump switch is also used to turn on the heating element so as to start its heating operation when it is detected that the tilt angle of the base has not exceeded the limit.

5. The swingable solar electric heater of claim 4, characterized in that:
the head swing element starts to swing back and forth when receiving the human body matching signal, and stops swinging back and forth when receiving the human body unmatching signal.

6. The swingable solar electric heater of claim 5, characterized in that:
the size of the filtering window used in the median filtering operation is proportional to the total area of the blockage.

7. The swingable solar electric heater of claim 6, characterized in that:
in the intelligent blocking device, the smaller the degree of blurring of the Wiener filtered image, the greater the number of image blocks obtained by performing blocking processing on the Wiener filtered image.

8. The swingable solar electric heater of claim 7, characterized in that:
detecting each edge line in the combined image of blocks using the line measurement device to obtain the number of edge lines in the combined image of blocks which includes: identifying each target shape in the combined image of blocks, whereby one or more lines composing each target shape are regarded as one or more edge lines.
